(19) United States
(12) Patent Application Publication
(10) Pub. No.: US 2019/0009310 A1
(43) Pub. Date: Jan. 10, 2019

(54) VEHICLE BODY WASH SYSTEM AND AN ASSOCIATED METHOD

(71) Applicant: ALSTOM Transport Technologies, Saint-Ouen (FR)

(72) Inventor: Jorge Pereira, Biarritz (FR)

(21) Appl. No.: 16/025,618

(22) Filed: Jul. 2, 2018

(30) Foreign Application Priority Data
Jul. 5, 2017 (FR) 17 56344

(51) Int. Cl. B08B 3/10; B08B 1/00; A46B 15/00; B08B 3/14; B03C 1/28; B60S 3/04; B60S 3/00; B61K 13/00

(52) U.S. Cl. CPC B08B 3/10; B08B 1/00; A46B 15/0026; B61K 13/00; B03C 1/28; B60S 3/04; B60S 3/006; B08B 3/14

(57) ABSTRACT

The invention relates to a vehicle body wash system comprising: a spray device for spraying a wash fluid on the body, the wash fluid comprising magnetic applicators; and a magnetic field generator, able to set the magnetic applicators in motion such that they rub the body.

### CROSS-REFERENCE TO RELATED APPLICATIONS

This application claims priority from French Patent Application No. 17 56344 filed on Jul. 5, 2017. The content of this application is incorporated herein by reference in its entirety.

### FIELD

The present invention relates to a vehicle body wash system and an associated wash method.

The present invention in particular applies to the cleaning of a railway vehicle.

### BACKGROUND

To clean a railway vehicle, cleaning systems are known comprising a roll of rotary brushes. However, such systems consume a large quantity of water and detergent products.

### SUMMARY OF THE INVENTION

One of the aims of the invention is therefore to provide an effective wash system reducing the quantity of water and detergents to be used.

To that end, the invention relates to a vehicle body wash system comprising a device for spraying a wash fluid on the body, the wash fluid comprising magnetic applicators, and a magnetic field generator, able to set the magnetic applicators in motion such that they rub the body.

According to other embodiments, the vehicle body wash system comprises one or more of the following optional features, considered alone or according to any technically possible combinations:
the magnetic field generator includes at least three coils supplied with controllable voltages.
the generator comprises an inverter.
the spray device is made from a non-magnetizable material.
the applicators comprise a magnetizable core surrounded by a porous layer.
the applicators comprise brush bristles.
the wash system comprises a retractable wash device for washing the front face and the rear face of the vehicle.
the wash system comprises a recovery system for the applicators.
the wash fluid comprises a mixture of lathered soapy water forming a foam, and
the recovery system comprises a magnetic separating system configured to separate the applicators from a fluid containing the applicators, in particular a foam.

The invention further relates to a vehicle body wash method comprising the following steps for spraying a wash fluid on the body, the wash fluid comprising a plurality of magnetic applicators, setting the applicators in motion via a magnetic field generator, such that the applicators rub the body.

### BRIEF DESCRIPTION OF THE DRAWINGS

The invention and its advantages will be better understood upon reading the following description, provided solely as a non-limiting example, and done in reference to the appended drawings, in which:

FIG. 1 shows a system for washing the body of a vehicle according to the invention.

FIG. 2 shows a magnetic applicator.

FIG. 3 shows a sectional view along plane III of the wash system of FIG. 1.

FIG. 4 shows a magnetic field generator.

### DETAILED DESCRIPTION

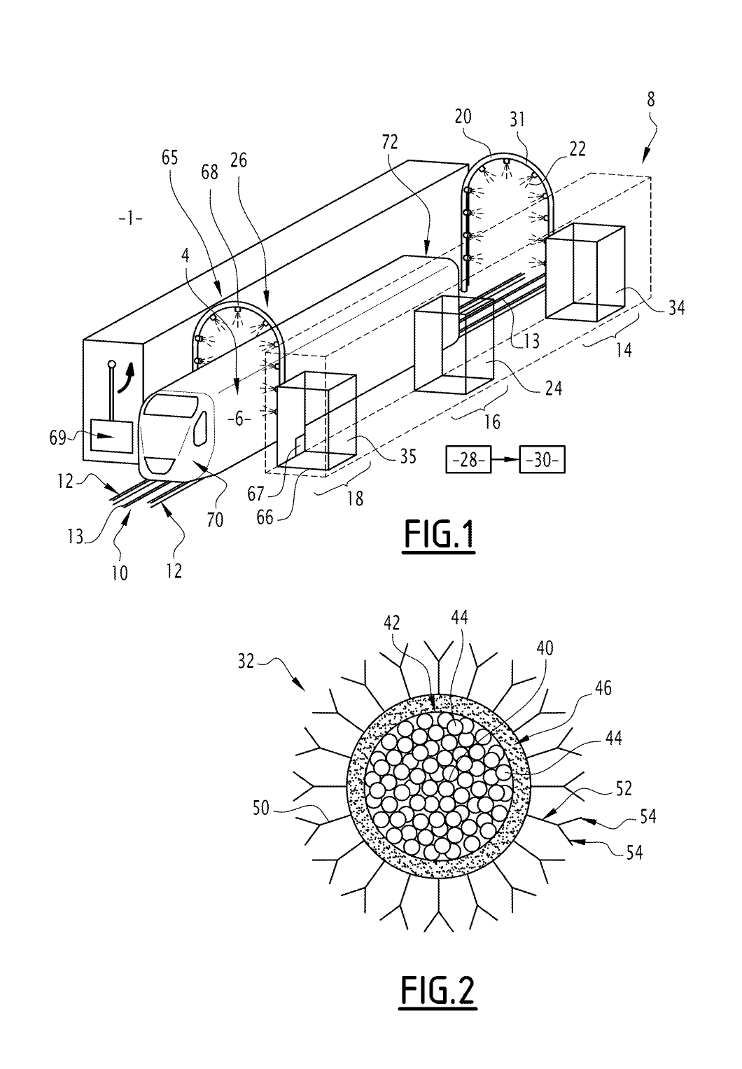

In reference to FIG. 1, a wash system 8 for the body 4 of a vehicle 6 is arranged on a wash site 1.

The vehicle 6 is for example a railway vehicle such as a train, tram, subway, etc.

The wash system 8 comprises a wash track 10. The wash track 10 advantageously comprises rails 12 allowing the vehicle 6 to move during cleaning thereof. The wash track 10 for example comprises a spray zone 14, a wash zone 16 and a rinse zone 18 successively along the wash track 10. The spray zone 14 is for example at the entrance of the wash track 10.

The wash track 10 further comprises a supply line 13 of the vehicle 6 to supply the vehicle 6 with electrical energy. In the example of FIG. 1, the supply line 13 is located on the ground, here between the two rails 12. The supply of the vehicle 6 makes it possible to advance the vehicle 6 along the wash track 10.

The wash system 8 comprises at least one device 20 for spraying a wash fluid 22, a magnetic field generator 24 and a recovery system 26. Furthermore, advantageously, the wash system 8 comprises a position sensor 28 of the vehicle and a controller 30.

The spray device 20 is configured to spray wash fluid 22 on the body 4 of the vehicle 8 in the spray zone 14. The wash system 8 comprises one or several spray devices 20 in order to wet or pre-wet the entire vehicle 6.

The spray device 20 for example comprises at least one wetting arch 31 in order to allow the vehicle 6 to pass below the wetting arch 31, provided with spray devices distributed on the wetting arch 31. For example, the spray devices are arranged on either side of the rails 12 in the spray zone 14.

The wash fluid 22 is for example a mixture of lathered soapy water and magnetic applicators 32. The mixture of lathered soapy water forms a foam.

The spray device 20 advantageously comprises reservoirs 34 of water, soap, applicators 32 and/or wash fluid 22.

For example, the reservoirs 34 are fluidly connected to the recovery system 26 by recirculation pipes, not shown. Thus, the spray device 20 can spray wash fluid 22 comprising recycled water and/or recycled applicators 32.

The foam and applicators 32 are stored separately and mixed to form the wash fluid 22 and/or stored in the form of a wash fluid 22.

Advantageously, the spray device 20 comprises a mixer to prepare the wash fluid 22 containing the foam and the applicators 32. Alternatively, the foam is sprayed before the applicators 32. Alternatively, the foam is sprayed after the applicators 32.

The applicator 32 is for example a magnetic sponge or a magnetic brush 32. Preferably, the applicator 32 is a magnetic micro-brush.

A magnetic applicator 32 is shown in detail in FIG. 2.

For example, the diameter of the applicator 32 is comprised between 1 mm and 10 mm.

The magnetic applicator 32 comprises a magnetizable core 40 surrounded by a shell 42.

The magnetizable core 40 comprises magnetized microbeads 44. The magnetizable core 40 makes up, under the influence of a magnetic field, a metal core behaving like a magnet.

The shell 42 is a protective sheath. The shell 42 is preferably flexible. The shell 42 is for example made from rubber or plastic. The shell 42 makes it possible to protect the microbeads 44 of the core 40 from corrosion while protecting the body 4 of the vehicle.

The shell 42 is advantageously covered with a porous layer 46. The porous layer 46 is for example a sponge or a foam including many porosities able to store foam from the wash fluid 22.

In one example, each applicator 32 comprises a surface layer formed by brush bristles 50, here Y-shaped. The bristles 50 are advantageously equivalent to the brush bristles present in the existing rotary brushes of cleaning systems used in the field of cleaning vehicle bodies. These bristles 50 make it possible to increase the cleaning power of the applicators 32. Indeed, each bristle 50 includes a branch 52 connecting to the applicator 32 and at least two friction branches 54, each friction branch 54 being able to come into contact with the body 4 of the vehicle 6.

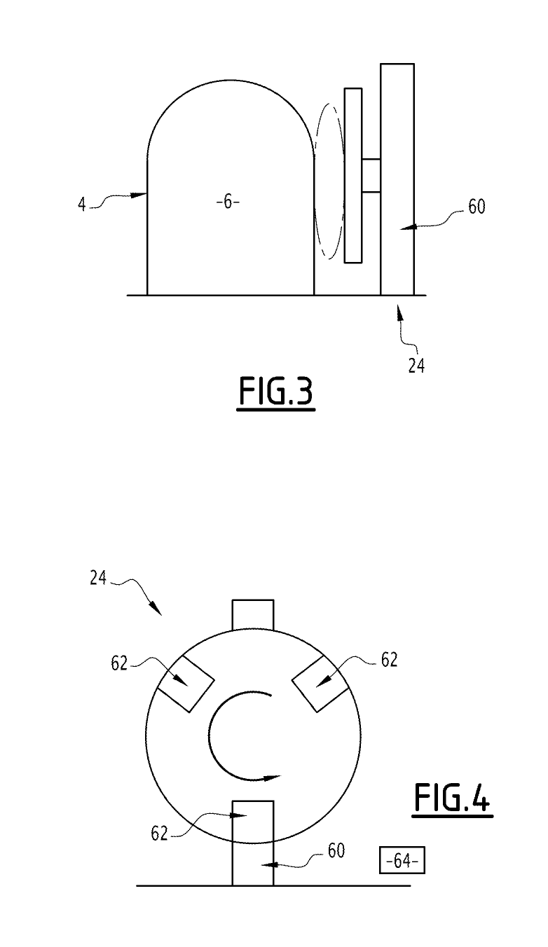

The magnetic field generator 24 is shown in more detail in FIGS. 3 and 4.

The magnetic field generator 24 is configured to generate a movable magnetic field in order to set the applicators 32 in motion such that they rub on the body 4.

The magnetic field generator 24 is mounted, opposite the wash zone 16, on an adjustable arm 60 so as to be able to pivot or adjust heightwise. For example, the arm 60 is a motorized mast. This configuration makes it possible to access the various nooks and crannies of the vehicle 4.

The magnetic field generator 24 here rotates and is able to set the applicators 32 of the wash fluid 22 dispersed on the body 4 in rotation, such that they rub on the body 4.

The rotary magnetic field generator 24 advantageously comprises three electric coils 62 supplied by balanced sinusoidal supply voltages phase-shifted by 2π/3 relative to one another. This arrangement of the coils 62 allows the magnetic field generator 24 to create a rotary magnetic field whose speed is proportional to the electric supply frequency of the coils, according to Ferraris theorem.

Alternatively, the generator 24 comprises more than three coils 62. If the number of coils is N, N being an integer greater than three, their balanced sinusoidal supply voltages are phase-shifted by 2π/N relative to one another. The speed of the movement of the applicators 32 of the wash fluid 22 depends on the supply frequency of the network. The magnetic field generator 24 advantageously comprises an inverter 64, causing the supply frequency of the coils 62 to vary so as to make it possible to vary the wash speed achieved by the applicators 32.

The currents and the distance of the field generator 24 from the wash track 10 are advantageously adjusted so that the inside parts of the vehicle 4 are not impacted by the magnetic field.

The magnetic effect of the magnetic field generator 24 makes it possible to transmit a movement force to each of the applicators 32 of the wash fluid 22. The applied force is such that the applicators 32 can loosen the dirt attached to the vehicle 6 without damaging the latter. For example, the force applied to each of the applicators 32 of the wash fluid is less than or equal to 10 kg/m².

The recovery system 26 is configured to recover the applicators 32 at the end of the washing. It advantageously comprises a rinse device 65, a recycling system 66 and a magnetic separating system 67.

The rinse device 65 is able to spray pressurized water on the vehicle 6. Advantageously, the rinse device 65 is able to send soft water. Advantageously, the rinse device 65 is supplied with water by at least one reservoir 34 containing water.

The rinse device 65 for example comprises a rinsing arch 68 straddling the wash track 10 and provided with spray devices distributed on the rinsing arch 68.

The recycling system 66 advantageously comprises at least one decanting vessel 35 making it possible to decant the fluid recovered by the recovery system 26 and containing applicators 32.

The magnetic separating system 67 is configured to separate the applicators 32 from a fluid containing the applicators 32 and recovered by the recovery system 26.

The position sensor 28 of the vehicle 6 is able to locate the vehicle 6 on the wash track 10.

The controller 30 is able, based on the position determined by the sensor 28, to activate the spray device 20, the recovery system 26, or to modify the commands of the spray device 20, the magnetic field generator 24 and the recovery system 26. For example, the controller 30 makes it possible to modify the power of the wash fluid jets 22, to modify the commands of the inverter 64 and the supply frequencies of the coils 62 based on the part of the vehicle 6 present in the spray zone 14, in the wash zone 16 or in the rinse zone 18.

Advantageously, the wash system 8 further comprises a retractable device 69, able to be placed across from the front face 70 of the vehicle 6 or the rear face 72 of the vehicle 6 for cleaning thereof. For example, the retractable device 69 is a pendular system; alternatively, the retractable device 69 is pivotable or translatable along an axis perpendicular to the wash track 10. The retractable device 69 for example comprises a spray device 20 and a small magnetic field generator 24.

Advantageously, the spray device 20, the recovery system 26 are equipped with non-magnetizable pipes, for example made from plastic.

The operation of the wash system 8 for the body 4 will now be described.

The vehicle 6 to be cleaned is guided in the wash zone 16 by the rails 12.

The spray device 20 sprays wash fluid 22 on the body 4.

The water, the soap and the applicators 32 are advantageously mixed before spraying. Alternatively, the foam is sprayed before sending the magnetic applicators 32.

The porous layer 42 of the applicators 33 absorbs foam.

The water used in the wash fluid 22 can come from the recovery system 26 or a distribution system for municipal water and/or rainwater.

The vehicle 6 is advanced on the wash track 10 such that a part covered with wash fluid 22 arrives in the wash zone 16, across from the magnetic field generator 24.

The wash fluid 22 is subjected to the magnetic field by the magnetic field generator 24.

The applicators 32 are set in motion along the magnetic field lines, and carry the foam along.

When the wash fluid 22 is subject to this magnetic field, each applicator 32 behaves like a magnet and moves at a speed given by the supply electrical frequency. During this movement, the applicator 32 comes into contact with the body 4 and rubs on it while releasing foam present in the porous layer 46. This rubbing makes it possible to detach dirt.

Repeating the process makes it possible to loosen all of the dirt. The applicators 32 move and gravity causes the dirt to fall following the repetitive movement.

When the magnetic field is a rotary field, washing with the applicators 32 makes it possible to detach the dirt by rotary effect.

In one example, the rotation direction of the magnetic field alternates during the washing phase by modification of the current supplied to the electric coils 62 using the controller 30.

Likewise, during this washing, the front and rear faces 70, 72 of the vehicle are cleaned by the retractable device 69.

Following the cleaning, the vehicle 6 arrives in the rinse zone 18.

In the rinse zone 18, the rinsing arch 68 sends rinse water, which will drain the applicators 32. The applicators 32 and the foam, which are polluted, are recovered by the recovery system 26. They are for example stored in the decanting vessel 35.

The magnetic system 67 makes it possible to separate the applicators 32 from the recovered fluid.

The applicators 32 are advantageously cleaned in a tub for a later use. They are then for example stored in a reservoir 34 of the spray device 20 while waiting for the next use.

In one alternative, the supply line 13 on the ground is replaced by an overhead supply line located above the vehicle 6. In this alternative, each wetting 31 or rinsing 68 arch can be replaced by two wetting or rinsing bars arranged on either side of the wash track 10, to free a passage for the supply line 13 above the vehicle 6. Such a wash system 8 makes it possible to reduce the maintenance costs and simplify cleaning because it is no longer necessary to use cumbersome mechanical wash brushes. The installation and placement of the wash system 8 is simpler and faster. Furthermore, the recycling of the applicators 32 makes it possible to use a small quantity of consumables.

The effect of the magnetic field applied to the applicators 32 replaces the brushing generated by the wash brushes with a conventional washing machine. The multiplication of the number of applicators 32 allows effective cleaning replacing the use of a single large brush that is difficult to maneuver.

1. A vehicle body wash system comprising:
a spray device for spraying a wash fluid on the body, the wash fluid comprising magnetic applicators, and
a magnetic field generator, able to set the magnetic applicators in motion such that they rub the body.

2. The wash system according to claim 1, wherein the magnetic field generator includes at least three coils supplied with controllable voltages.

3. The wash system according to claim 1, wherein the magnetic field generator comprises an inverter.

4. The wash system according to claim 1, wherein the spray device is made from a non-magnetizable material.

5. The wash system according to claim 1, wherein the applicators comprise a magnetizable core surrounded by a porous layer.

6. The wash system according to claim 1, wherein applicators comprise brush bristles.

7. The wash system according to claim 1, wherein the wash system comprises a retractable wash device for washing the front face and the rear face of the vehicle.

8. The wash system according to claim 1, comprising a recovery system for the applicators.

9. The wash system according to claim 8, wherein the recovery system comprises a magnetic separating system configured to separate the applicators from a fluid containing the applicators.

10. A method for washing a vehicle body, comprising the following steps:
spraying a wash fluid on the body, the wash fluid comprising a plurality of magnetic applicators,
setting the applicators in motion via a magnetic field generator, such that the applicators rub the body.
